(19) United States
(12) Patent Application Publication
(10) Pub. No.: US 2008/0299517 A1
(43) Pub. Date: Dec. 4, 2008

(54) Denture with suction attachment

(76) Inventor: Page W. Delaney, II, Central City, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/806,684

(22) Filed: Jun. 1, 2007

(51) Int. Cl. A61C 13/24

(52) U.S. Cl. 433/185; 433/184

(57) ABSTRACT

The denture with suction attachment is an upper or lower denture plate having a floor with at least one suction cavity formed therein, at least one check valve for sealing the chamber formed by the suction cavity and the user's mouth when the denture is installed therein, and at least one suction passage extending between the valve and one suction cavity. The suction cavity may have one or more cavities extending generally across the span of an upper plate, or along the gum line of a lower plate. The suction cavity or cavities are preferably provided with a peripheral seal of a soft, resilient silicone material, or other suitable seal. A suction pump is also provided for removable attachment to the check valve. A magnetic attachment is preferably provided for securing the end of the interconnecting suction pump line to the check valve of the denture.

### BACKGROUND OF THE INVENTION

1. Field of the Invention

The present invention relates generally to dental appliances. More specifically, the present invention relates to a denture with suction attachment so that the denture is held in place in the mouth of the user by applying suction through a check valve to reduce air pressure within a suction cavity within the denture.

2. Description of the Related Art

Temporarily installed artificial tooth structures, e.g., bridgework and denture plates, have been known for a considerable period of time. Such dentures are conventionally held in place in the mouth by mechanical means, e.g., a closely fitting structure that secures to other natural teeth in the mouth, or by adhesive means, e.g., denture cream. In situations where complete denture plates are used, an adhesive has been conventionally used for attachment in the mouth, as no natural tooth structure remains for mechanically attaching the denture structure in the mouth.

More recently, various dentures have been developed that use a partial vacuum (suction) between the denture and the mouth structure to hold the dental plate in place in the mouth. An example of such is found in German Patent No. 3,836,885, published on May 3, 1990. The '885 patent describes (according to the drawings and English abstract) a denture held in place by partial vacuum, the denture having a highly flexible sealing lip to provide a vacuum seal. Non-return valves, i.e., check valves, apparently comprising flexible flap seals, are provided in the denture structure.

Thus, a denture with suction attachment solving the aforementioned problems is desired.

### SUMMARY OF THE INVENTION

The denture with suction attachment is an upper or lower denture plate having a mouth contact surface or floor with at least one suction cavity formed therein, at least one check valve for sealing the suction chamber formed by the suction cavity and the mouth of the user when the denture is installed therein, and at least one suction passage extending between the at least one valve and the at least one suction cavity. The suction cavity may be formed by one or more cavities extending generally across the span of the peripheral gum recess of an upper plate, or along the gum line of a lower plate. The suction cavity or cavities are preferably provided with a peripheral seal of a soft, resilient silicone material, or other suitable seal.

A manually actuated suction pump is also provided for removable attachment to the check valve. Alternatively, the pump may be electrically powered. A magnetic attachment is preferably provided for securing the end of the interconnecting suction pump line or tube to the check valve of the denture. The denture may incorporate multiple suction cavities, multiple valves, and/or multiple internal passages between the cavity or cavities and the valve(s). The suction check valve(s) of the denture preferably includes multiple sealing elements therein, with the suction pump also preferably including at least two sealing elements.

A user of the denture with its suction attachment need only position the denture properly in the mouth, attach the suction line from the pump to the valve of the denture, and draw a partial vacuum by actuating the suction pump. The check valve automatically seals the partial vacuum within the suction chamber of the denture and user's mouth when the suction line is removed. The process is applied to other vacuum cavities having separate check valves, as required. The denture is quickly and easily removed when desired by opening the check valve(s) with a small rod, pin, or the like to equalize the air pressure within the suction cavity with that of the ambient air.

These and other features of the present invention will become readily apparent upon further review of the following specification and drawings.

### BRIEF DESCRIPTION OF THE DRAWINGS

FIG. 1 is an environmental, perspective view of a denture with suction attachment according to the present invention, showing its installation.

FIG. 2 is a perspective view of an exemplary upper denture plate with suction attachment according to the present invention, showing various details thereof.

FIG. 3 is a bottom plan view of a lower denture with suction attachment according to the present invention, showing various details thereof.

FIG. 4 is an enlarged, exploded, detail elevation view in section of a valve and vacuum line connection used in a denture with suction attachment according to the present invention.

FIG. 5 is a side elevation view in section of a manually actuated suction pump for use with a denture with suction attachment according to the present invention.

Similar reference characters denote corresponding features consistently throughout the attached drawings.

### DETAILED DESCRIPTION OF THE PREFERRED EMBODIMENTS

The present invention relates to a denture, specifically, a dental plate, which is removably secured within the mouth of the user by suction. The denture includes various valve mechanisms and a separate, externally disposed manually or electrically actuated suction pump, which is removably connected to the denture to produce and apply the suction required to secure the denture in the mouth of the user.

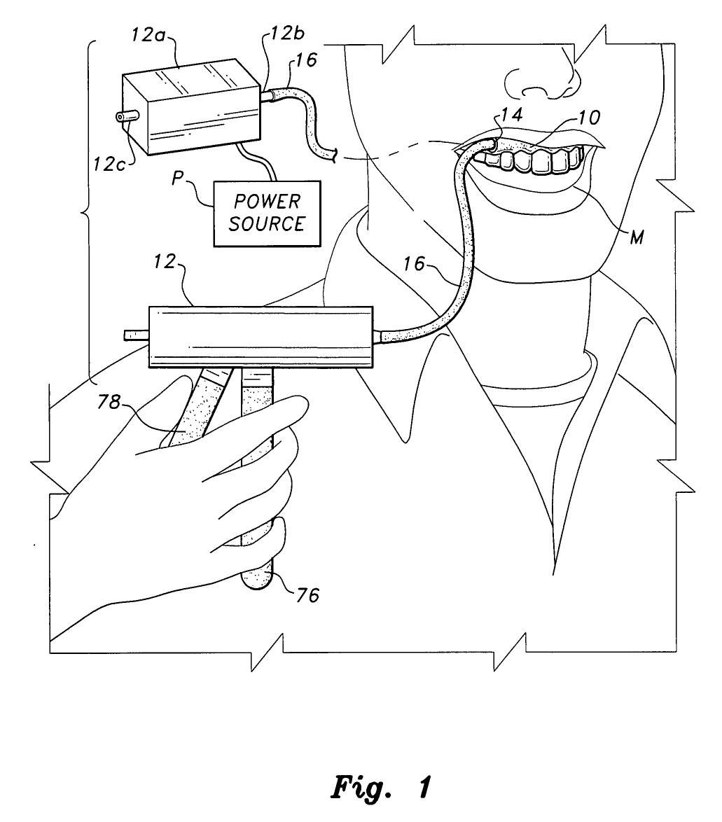

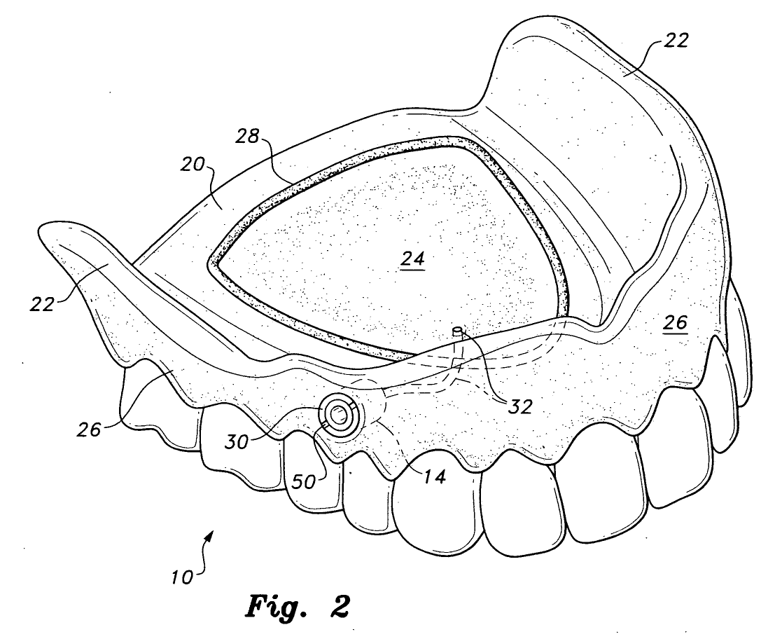

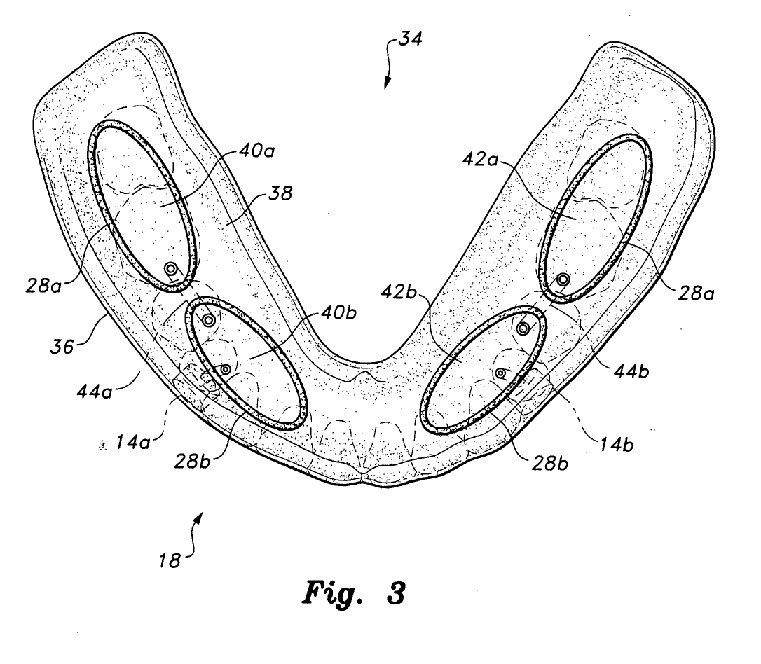

FIG. 1 of the drawings provides an environmental perspective view of an exemplary denture, e.g., upper plate 10, in the process of being secured in the mouth M of the user or wearer. The user is manipulating an external, handheld suction pump 12, which is removably connected to a suction check valve 14 in the dental plate 10 by a suction tube or line 16. The suction tube or line is preferably rigid or semi-rigid, but may be a length of flexible plastic tubing or may have a short flexible length of tubing extending from the rigid line. The suction attached denture may comprise an upper plate 10 that spans the roof of the mouth, as shown in the environmental view of FIG. 1 and in the perspective view of FIG. 2, or a lower plate 18, shown in a bottom plan view in FIG. 3. The dental plate 10 may be a full denture or a partial plate, as desired. FIG. 1 also illustrates an alternative electrically actuated pump 12a, e.g., a conventional aquarium pump or the like. The pump 12a includes a suction inlet 12b to which the suction tube or line 16 may be connected, and an outlet 12c. The pump 12a may be powered by any suitable electrical power supply P, e.g., 115-volt ac from the conventional electric grid, or battery power in accordance with the electrical needs of the pump.

FIG. 2 provides a detailed illustration of an exemplary full or complete upper dental plate 10 in accordance with the invention. The upper plate 10 includes a floor 20 which contacts the periphery of the upper mouth of the wearer of the denture, with the floor 20 having a generally U-shaped peripheral wall 22 substantially conforming about the gum line of the wearer of the plate 10. The peripheral wall 22 at least partially surrounds a suction recess defining a cavity 24 formed within the floor 20 of the plate 10, with the cavity 24 being disposed immediately adjacent the roof of the mouth when the plate 10 is properly installed within the mouth of the user, and includes an outwardly facing peripheral surface 26 opposite the inwardly disposed suction cavity 24. It should be understood that the cavity 24 does not extend completely through the floor 20 of the dental plate 10, i.e., there is no passage through the plate 10. Rather, the cavity 24 merely provides slight clearance for the mouth structure of the wearer of the present dental plate 10 in order that the plate will fit securely within the mouth of the wearer, with the cavity 24 providing a suction chamber to secure the plate 10 in place within the user's mouth.

The suction cavity 24 preferably includes a peripherally disposed soft, pliable seal 28. The seal 28 is preferably formed of a silicone plastic material, which remains soft and pliable. An example of such material is known as “Cusil,” used in dentistry as a bonding agent for securing artificial teeth in a dental bridge, plate, or the like. The seal 28 is preferably provided with a relatively thin distal edge in order to provide greater flexibility and conformity to the contours of the roof of the mouth. A single suction check valve 14 is installed within the peripheral wall 22 of the plate 10, with its outer face 30 disposed to the outer surface 26 of the peripheral structure 22 of the plate 10 in order to facilitate the removable attachment of the suction tube or line 16 thereto. A suction passage 32 extends between the suction recess or cavity 24 and the check valve 14, to provide fluid communication between the cavity 24 and check valve 14.

FIG. 3 provides a bottom plan view of a lower denture plate 18 in accordance with the present invention. The lower plate 18 includes an open central area 34 providing clearance for the base of the tongue. This open central area 34 is at least partially surrounded by a depression, valley, or floor 38, somewhat analogous to the floor 20 of the dental plate 10 of FIG. 2, with the outer edge of the floor 38 being bound by a generally U-shaped wall 36 substantially conforming to the outwardly facing side of the lower gum line of the wearer of the plate 18. The gum depression or floor 38 includes a plurality of recesses or depressions defining suction cavities 40a, 40b and 42a, 42b therein. A pair of adjacent suction cavities 40a, 40b are disposed within one side of the gum seating depression or floor 38, with the opposite pair of mutually adjacent suction cavities 42a, 42b being disposed on the opposite side of the floor 38. Each of the suction cavities 40a, 40b, 42a, 42b is surrounded by a soft, pliable peripheral seal 28a or 28b, preferably formed of the same material as the seal 28 of the upper plate 10 of FIG. 2.

The two adjacent suction cavities of each pair are connected together by a suction passage, i.e., the two suction cavities 40a, 40b are joined to one another by suction passage 44a and the two suction cavities 42a, 42b are joined to one another by suction passage 44b. This allows each pair of suction cavities to be served by a single suction check valve, i.e., the first suction check valve 14a communicating with the frontal suction cavity 40a, and the second suction check valve 14b communicating with the frontal suction cavity 42a.

It will be noted that the application of suction to either valve 14a or 14b will apply suction to only two of the four suction cavities of the lower plate 18, as the left and right side pairs of cavities are not interconnected. Alternatively, each cavity could be provided with its own valve, or all cavities within a plate could be interconnected by corresponding suction passages. Moreover, more or fewer suction recesses and/or valves than shown in FIG. 3 may be used, if necessary, with corresponding interconnecting suction passages, as required.

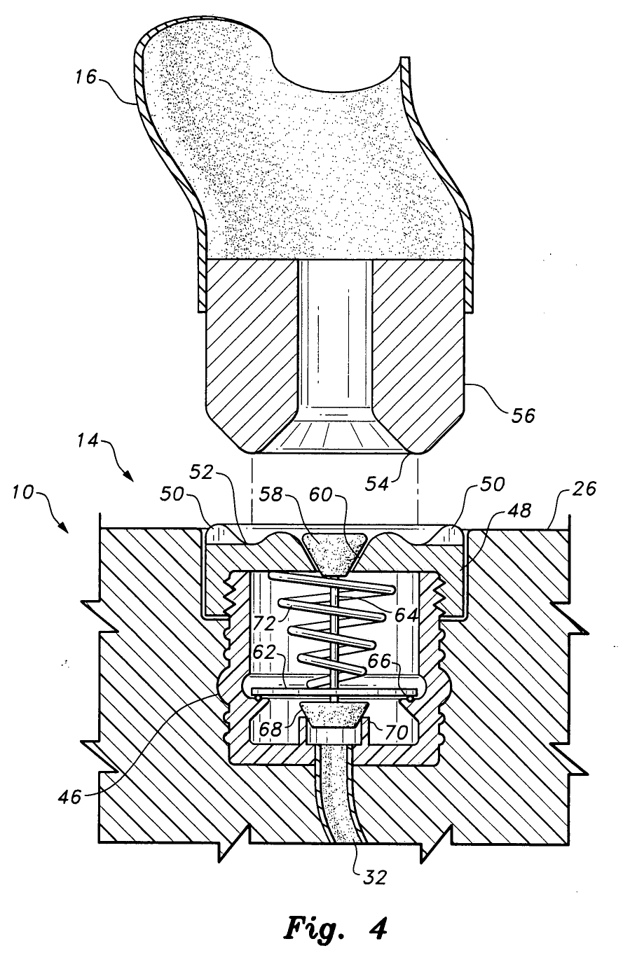

FIG. 4 provides a detailed elevation view in section of an exemplary suction check valve 14 (the valves 14a and 14b of FIG. 3 are essentially identical to the valve 14) and distal end of the flexible suction tube, hose, or line 16. The suction check valve 14 has a body 46 which is molded in place or otherwise permanently secured within the outer periphery 26 of the denture 10. The structure shown in FIG. 4 is essentially the same as for a valve 14a, 14b installed in the lower denture plate 18 of FIG. 3. The inner end of the valve body 46 connects to the suction passage 32 to draw air from the suction cavity or cavities of the denture.

The upper or outwardly disposed end of the valve body 46 is capped by a semi permanently installed valve cap 48, which is threaded in place upon the valve body 46. Opposed slots 50, also shown in FIG. 2, or other tool gripping means may be provided across the valve cap 48 to provide for its removal in order to clean the interior of the valve, replace internal components, etc. as required. The valve cap 48 preferably includes a concentric annular depression 52, which fits removably onto a corresponding annular ring 54 extending from the distal end component 56 of the flexible tube 16.

Either the valve cap 48 or the annular ring 54, or both, may be formed of a magnetic material, with at least one of the two components 48 or 54 being formed of magnetic material and the opposite component being formed of ferromagnetic material. This provides a positive, yet easily removable, attachment of the suction tube 16 to the denture body 10 in the form of a magnetic latch. It will be recognized that it is difficult for the user of the dental appliance to see the precise location of the valve(s) 14 of the device, particularly if no mirror is available. However, a person wearing the suction attached denture will quickly adapt to at least the approximate location of the valve(s) 14. The provision for a magnetic latch enables the user to position the distal end 56 of the flexible suction tube 16 in at least approximately the correct position, with the mutual magnetism of the two components 48 and 54 providing a sharp “click” which is detectable through the bone structure and/or aural facilities of the user as the components are drawn together when properly positioned.

The suction check valve 14 preferably includes a series of three separate valves therein, in order to provide more positive sealing. A first, external frustoconical valve 58 seats within a mating conical passage 60 formed concentrically within the valve cap 48. This first valve 58 is linked to a second, medial valve 62 by a connecting rod 64. The medial valve 62 is a circular disc which seats upon a mating valve seat and O-ring seal assembly 66 within the valve body 46. A third or internally disposed valve 68 having a frustoconical form extends from the connecting rod 64 opposite the first or external valve 58, and seats upon a concentric ring 70 surrounding the connection of the suction passage 32 to the base of the valve body 46. The three valves 58, 62, and 68 are urged toward their respective seats 60, 66, and 70 by a compression spring 72 disposed between the intermediate disc valve 62 and the overlying valve cap 48. Suction applied to the valve cap 48 draws the three interconnected valves 58, 62, and 68 from their respective valve seats 60, 66, and 70, thereby allowing air to be withdrawn from the suction recess of the denture through the suction passage 32.

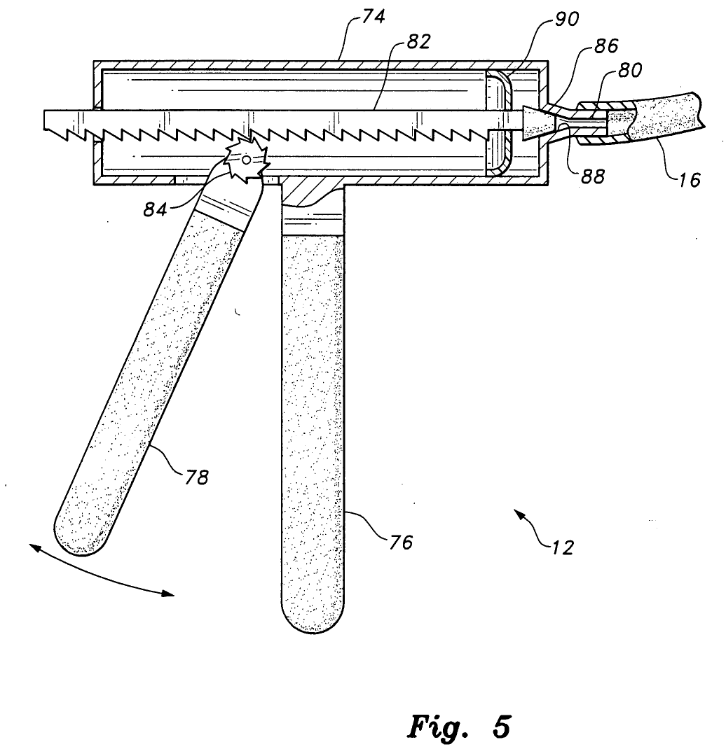

FIG. 5 provides a detailed side elevation view in section of the manually actuated suction pump 12 for use with the present denture with suction attachment embodiments. The pump 12 includes a hollow cylindrical body 74 having a fixed handle 76 extending therefrom, and a pivotally attached ratchet handle 78 adjacent to the fixed handle. A suction inlet 80 extends from one end of the body 74, with the suction hose or tube 16 attaching to the inlet 80. A serrated pump shaft or ratchet rod 82 extends generally concentrically through the body 74 of the device, with the ratchet wheel 84 of the ratchet handle 78 engaging the serrations or teeth of the ratchet rod or pump shaft 82 to draw the rod progressively rearwardly, i.e., away from the suction inlet 80 of the body 74 when the ratchet handle 78 is actuated. The distal forward end of the pump shaft 82, i.e., the end adjacent the suction inlet 80, includes a concentric first, frustoconical valve 86 thereon, which seats within a mating valve seat 88 forming the internal wall of the suction inlet 80. A second cup-type valve 90 is concentrically disposed upon the pump shaft 82 upon the distal end portion thereof, to form a seal between the shaft or rod 82 and the internal surface of the suction pump body 74. When the ratchet handle 78 is actuated, the pump shaft 82 is drawn away from the suction inlet 80, thereby withdrawing the conical valve 86 from its seat 88 and simultaneously drawing the cup valve 90 away from the suction inlet 80 to withdraw air from the suction cavity of the denture and into the pump body 74.

It is to be understood that the present invention is not limited to the embodiments described above, but encompasses any and all embodiments within the scope of the following claims.

I claim:

1. A denture with suction attachment, comprising:
a denture plate having a peripheral wall at least partially surrounding a floor;
at least one suction cavity disposed within the floor;
a suction check valve disposed within the peripheral wall;
a suction passage disposed between the suction check valve and the at least one suction cavity;
a suction pump; and
a suction tube extending from the suction pump, the suction tube having a distal end attachable to the suction check valve.

2. The denture with suction attachment according to claim 1, further including:
a first magnetically attractive material disposed within the suction check valve; and
a second magnetically attractive material disposed within the distal end of the suction tube, the first and second magnetically attractive materials forming a magnetic latch for removably attaching the distal end of the suction tube to the suction check valve.

3. The denture with suction attachment according to claim 1, wherein:
the suction check valve has three separate sealing elements disposed therein; and
the suction pump has at least two separate sealing elements disposed therein.

4. The denture with suction attachment according to claim 1, wherein said at least one suction cavity comprises a plurality of suction cavities.

5. The denture with suction attachment according to claim 1, wherein the suction pump is manually actuated and further includes a serrated pump shaft engaged by a ratchet handle for linear actuation thereof, the pump shaft further including concentric first and second seals disposed at the distal end thereof.

6. The denture with suction attachment according to claim 1, wherein the suction check valve comprises an internal frustoconical valve component, an intermediate disc valve component, and an external frustoconical valve component.

7. The denture with suction attachment according to claim 1, further including a soft, pliable seal disposed about the at least one suction cavity.

8. A denture with suction attachment, comprising:
a denture plate having a peripheral wall at least partially surrounding a floor;
at least one suction cavity disposed within the floor;
at least one suction check valve disposed within the outwardly facing peripheral surface;
at least one suction passage disposed between the at least one suction check valve and the at least one suction cavity;
a suction pump;
a suction tube extending from the suction pump, the suction tube having a distal end;
a first magnetically attractive material disposed within the at least one suction check valve; and
a second magnetically attractive material disposed within the distal end of the suction tube, the first and second magnetically attractive materials forming a magnetic latch for removably attaching the distal end of the suction tube to the at least one suction check valve of the denture plate.

9. The denture with suction attachment according to claim 8, wherein the suction pump is manually actuated and disposed externally to the denture plate.

10. The denture with suction attachment according to claim 8, wherein:
the at least one suction check valve has three separate sealing elements disposed therein; and
the suction pump has at least two separate sealing elements disposed therein.

11. The denture with suction attachment according to claim 8, wherein said at least one suction cavity comprises a plurality of suction cavities, said at least one suction check valve comprising a plurality of suction check valves.

12. The denture with suction attachment according to claim 8, wherein the suction pump is manually actuated and further includes a serrated pump shaft engaged by a ratchet handle for linear actuation thereof, the pump shaft having concentric first and second seals disposed at the distal end thereof.

13. The denture with suction attachment according to claim 8, wherein the at least one suction check valve comprises an internal frustoconical valve component, an intermediate disc valve component, and an external frustoconical valve component.

14. The denture with suction attachment according to claim 8, further including a soft, pliable seal disposed about the at least one suction cavity.

15. A denture with suction attachment, comprising:
a denture plate having a peripheral wall at least partially surrounding a floor;
at least one suction cavity disposed within the floor;
a soft, pliable seal disposed about the at least one suction cavity;
at least one outwardly facing suction check valve disposed within the peripheral wall, the suction check valve having three separate sealing elements disposed;
at least one suction passage disposed between the at least one suction check valve and the at least one suction cavity;
a suction pump having at least two separate sealing elements disposed therein; and
a flexible suction tube extending from the suction pump, the suction tube having a distal end attachable to the at least one suction check valve of the denture plate.

16. The denture with suction attachment according to claim 15, wherein the suction pump is manually actuated and disposed externally to the denture plate.

17. The denture with suction attachment according to claim 15, further including:
a first magnetically attractive material disposed within the at least one suction check valve; and
a second magnetically attractive material disposed within the distal end of the suction tube, the first and second magnetically attractive materials forming a magnetic latch for removably attaching the distal end of the suction tube to the at least one suction check valve.

18. The denture with suction attachment according to claim 15, wherein said at least one suction cavity comprises a plurality of suction cavities, said at least one suction check valve comprising a plurality of suction check valves.

19. The denture with suction attachment according to claim 15, wherein the suction pump is manually actuated and further includes a serrated pump shaft engaged by a ratchet handle for linear actuation thereof, the pump shaft having concentric first and second seals disposed at the distal end thereof.

20. The denture with suction attachment according to claim 15, wherein the at least one suction check valve comprises an internal frustoconical valve component, an intermediate disc valve component, and an external frustoconical valve component.
